(19) United States
(12) Patent Application Publication
(10) Pub. No.: US 2026/0357702 A1
(43) Pub. Date: Nov. 12, 2026

(54) METHOD AND SYSTEM FOR JUDGING DESTRUCTION OF WATER-BEARING SURROUNDING ROCK OF UNDERGROUND ENGINEERING

(71) Applicants: Shandong Jianzhu University, Jinan City (CN); Shandong Provincial Institute of Land Surveying and mapping, Jinan City (CN)

(72) Inventors: Yunjuan CHEN, Jinan City (CN); Fuqiang Yin, Jinan City (CN); Shuguang Song, Jinan City (CN); Jun Wang, Jinan City (CN); Hongtao Wang, Jinan City (CN); Dapeng Qiu, Jinan City (CN); Zeyong Jiang, Zibo City (CN); Mingxu Ding, Linyi City (CN); Hao Lv, Jinan City (CN); Ping Liu, Jinan City (CN)

(21) Appl. No.: 19/536,646

(22) Filed: Feb. 11, 2026

(30) Foreign Application Priority Data
May 7, 2025 (CN) 202510578820.7

(51) Int. Cl. E21F 17/18; E21B 49/00; G01V 1/30; G01V 1/50; G01V 20/00

(52) U.S. Cl. CPC E21F 17/185; E21B 49/00; G01V 1/306; G01V 1/50; G01V 20/00; G01V 2210/646

(57) ABSTRACT

A method and a system for judging water-bearing surrounding rock destruction of underground engineering are provided. The method includes: acquiring water pressure change data of water-bearing surrounding rock, combining a preset stress distribution model to calculate the change trend of the surrounding rock stress field, and simulating the microcrack propagation process by using a fracture propagation model; judging the nonlinear characteristics of fracture propagation based on the fracture propagation simulation results and the physical properties of the surrounding rock; analyzing the influence of water pressure fluctuations on the permeability of the surrounding rock, correcting the parameters of the fracture propagation model accordingly and recalculating the dynamic process; constructing a multi-dimensional judgment model for surrounding rock failure by using multi-field coupling analysis, combining time evolution data to dynamically capture the critical state, and predicting the development trend of failure by using a nonlinear dynamics algorithm.

### CROSS-REFERENCE TO RELATED APPLICATIONS

This application claims priority to Chinese Patent Application No. 202510578820.7, filed on May 07, 2025, the contents of which are hereby incorporated by reference.

### TECHNICAL FIELD

The present disclosure belongs to the technical field of water-bearing surrounding rock destruction in underground engineering, and in particular to a method and a system for judging water-bearing surrounding rock destruction of underground engineering.

### BACKGROUND

In underground engineering, such as hydropower station underground workshops, coal mine roadways, subway tunnels and other fields, the stability of water-bearing surrounding rock is one of the key factors affecting engineering safety. Existing technologies usually evaluate the stability of surrounding rock by monitoring parameters such as water pressure, surrounding rock stress and fracture propagation. These methods may reflect a stress state and destruction trends of surrounding rock to a certain extent. For example, water pressure monitoring may help understand the impact of water-bearing conditions on surrounding rock; stress analysis may reveal the stress distribution of surrounding rock; and fracture propagation models may be used to predict the development direction and speed of fractures. In addition, some studies have also introduced permeability analysis to evaluate the impact of water pressure changes on the permeability of surrounding rock. These technical means provide basic data support for the stability evaluation of surrounding rock and may guide engineering practice to a certain extent.

However, existing technologies have significant shortcomings in the judgment of surrounding rock destruction. Firstly, most existing methods are based on the analysis of a single physical field, ignoring the mutual coupling relationship between multiple physical fields such as water pressure, stress, fracture propagation and permeability. This isolated analysis method may not accurately reflect the complex dynamic characteristics of surrounding rock under water-bearing conditions, resulting in limited accuracy and reliability of judgment results. Secondly, when dealing with the nonlinear characteristics of fracture propagation, existing technologies often adopt simplified linear models, which are difficult to truly reflect the complex process of fracture propagation. In addition, the dynamic capture capability of existing methods in the time dimension is insufficient, and they may not effectively track the evolution of the critical state of surrounding rock destruction.

### SUMMARY

In order to solve the above technical problems, the present disclosure proposes a method and a system for judging water-bearing surrounding rock destruction of underground engineering to address the problems existing in the above existing technologies.

In order to achieve the above object, in a first aspect, the present disclosure provides a method for judging water-bearing surrounding rock destruction of underground engineering, including following steps: acquiring water pressure change data of water-bearing surrounding rock, and combining a preset stress distribution model to calculate a change trend of the surrounding rock stress field; simulating a propagation process and a propagation direction of microcracks in the surrounding rock by using a fracture propagation model according to the change trend of the surrounding rock stress field; combining physical property parameters of the surrounding rock to discriminate nonlinear characteristics of fracture propagation based on simulation results of the propagation process of the microcracks; acquiring time series data of water pressure fluctuations and analyzing an influence law of water pressure on permeability of the surrounding rock; correcting parameters of a fracture propagation model according to changes of the permeability, and recalculating a dynamic process of fracture propagation; constructing a multi-dimensional judgment model for surrounding rock destruction by using a multi-field coupling analysis method based on a corrected dynamic process of the fracture propagation; acquiring time evolution data, and combining the multi-dimensional judgment model to dynamically capture a critical state of surrounding rock destruction; and predicting a development trend of surrounding rock destruction by using a nonlinear dynamics algorithm according to a change trend of the critical state.

Optionally, steps of the calculating the change trend of the surrounding rock stress destruction include acquiring the water pressure change data of the water-bearing surrounding rock, and extracting water pressure change values; combining a preset stress distribution model to extract stress modulus and distribution state according to the water pressure change values; and calculating the change trend of the surrounding rock stress destruction by using a pre-established calculation method.

Optionally, steps of the simulating the propagation process and the direction of the microcracks in the surrounding rock include acquiring stress field distribution state of the surrounding rock mass, and extracting stress values and the change trend thereof; combining stress value change trends to calculate a propagation direction of microcracks by using a fracture model; and analyzing a propagation process of the microcracks in the surrounding rock mass through a simulation process.

Optionally, steps of the judging the nonlinear characteristics of the fracture propagation include generating dynamic data of the fracture propagation, and extracting key change points through time series analysis; combining physical property parameters of the surrounding rock to analyze values of the of fracture propagation; and judging whether fracture propagation characteristic values reach a preset threshold to determine stability state of the surrounding rock mass.

Optionally, steps of the recalculating the dynamic process of the fracture propagation include acquiring the time series data of the permeability, and extracting the change trend of the permeability; correcting values of the parameters of the model by using a preset fracture propagation model according to the change trend of the permeability; and recalculating the dynamic process of the fracture propagation according to the corrected values of the parameters to obtain the evolution result of fracture propagation.

Optionally, step of the constructing the multi-dimensional judgment model for the surrounding rock destruction by using the multi-field coupling analysis method include: acquiring data of the corrected dynamic process of the fracture propagation, and extracting characteristic indicators of the surrounding rock destruction by using the multi-field coupling analysis method; constructing a multi-dimensional judgment model according to the characteristic indicators of surrounding rock destruction to determine key characteristics of surrounding rock destruction; and training the multi-dimensional judgment model by using a support vector machine algorithm according to the key characteristics of surrounding rock destruction to obtain a trained multi-dimensional judgment model.

Optionally, steps of the dynamically capturing the critical state of the surrounding rock destruction include acquiring the time series data in the evolution process of the surrounding rock, and extracting evolution characteristics; dynamically capturing extracted evolution characteristics by using the multi-dimensional judgment model; and determining the critical state of surrounding rock destruction when the dynamically captured characteristics meet the preset critical state conditions.

Optionally, steps of the predicting the development trend of the surrounding rock destruction include acquiring time series data of a surrounding rock mass, and extracting characteristic values in an evolution process of the surrounding rock; establishing a prediction model by using a nonlinear dynamics algorithm according to a change trend of characteristic values; and analyzing a development trend of the surrounding rock destruction through the prediction model.

In a second aspect, the present disclosure also discloses a system for judging water-bearing surrounding rock destruction of underground engineering, where the system includes: a water pressure change data acquisition module, configured for acquiring water pressure change data of a water-bearing surrounding rock, and combining a preset stress distribution model to calculate a change trend of surrounding rock stress field; a stress field calculation module, configured for simulating a propagation process and a propagation direction of microcracks in a surrounding rock by using a fracture propagation model according to a change trend of stress field; a fracture propagation simulation module, configured for combining physical property parameters of the surrounding rock to discriminate nonlinear characteristics of fracture propagation based on simulation results of the propagation process of fracture; a nonlinear characteristic judgment module, configured for acquiring time series data of water pressure fluctuations and analyzing an influence law of water pressure on permeability of the surrounding rock; a water pressure fluctuation analysis module, configured for correcting parameters of the fracture propagation model according to changes in the permeability, and recalculating the dynamic process of fracture propagation; a fracture propagation model correction module, configured for constructing a multi-dimensional judgment model for the surrounding rock destruction by using a multi-field coupling analysis method based on a corrected dynamic process of fracture propagation; a multi-dimensional judgment model construction module, configured for acquiring time evolution data, and combining the multi-dimensional judgment model to dynamically capture critical state of the surrounding rock destruction; and a critical state capture module, configured for predicting a development trend of the surrounding rock destruction by using a nonlinear dynamics algorithm according to the change trend of the critical state.

In third aspect, the present disclosure also discloses a computer program product, including a computer program, where the computer program product implements the steps of the method described in the first aspect, when the computer program product is executed by a processor.

Compared with the prior art, the present disclosure has the following advantages and technical effects.

The present disclosure discloses a method for judging water-bearing surrounding rock destruction of underground engineering. The method first acquires water pressure change data of water-bearing surrounding rock, combines a preset stress distribution model to calculate the change trend of the stress field, and simulates the microcrack propagation process by using a fracture propagation model. Then, the nonlinear characteristics of fracture propagation are judged based on the simulation results of fracture propagation and the physical properties of the surrounding rock. Next, the influence of water pressure fluctuations on the permeability of the surrounding rock is analyzed, and the parameters of the fracture propagation model are corrected accordingly to recalculate the dynamic process. Finally, the present disclosure constructs a multi-dimensional judgment model for surrounding rock destruction by using multi-field coupling analysis, dynamically captures the critical state in combination with time evolution data, and predicts the development trend of destruction by using a nonlinear dynamics algorithm. Through multi-dimensional data analysis and model iterative optimization, the present disclosure realizes the accurate simulation and prediction of the surrounding rock destruction process under complex geological conditions, and provides important technical support for engineering safety.

### BRIEF DESCRIPTION OF THE DRAWINGS

The accompanying drawings forming a part of the present disclosure are used to provide a further understanding of the present disclosure. The schematic embodiments and descriptions of the present disclosure are used to explain the present disclosure and do not constitute an improper limitation of the present disclosure. In the accompanying drawings.

FIG. 1 is a flowchart of the method according to an embodiment of the present disclosure.

FIG. 2 is a graph of prediction accuracy according to an embodiment of the present disclosure.

FIG. 3 is a schematic diagram of an image for predicting the development trend of surrounding rock destruction according to an embodiment of the present disclosure.

FIG. 4 is a schematic diagram of the system according to an embodiment of the present disclosure.

### DETAILED DESCRIPTION OFTHE EMBODIMENTS

It may be noted that the embodiments in the present disclosure and the features in the embodiments may be combined with each other without conflict. The present disclosure will be described in detail below with reference to the accompanying drawings and embodiments.

It may be noted that the steps shown in the flowcharts of the accompanying drawings may be executed in a computer system such as a set of computer-executable instructions. Although a logical order is shown in the flowcharts, in some cases, the steps shown or described may be executed in an order different from that here.

### Embodiment 1

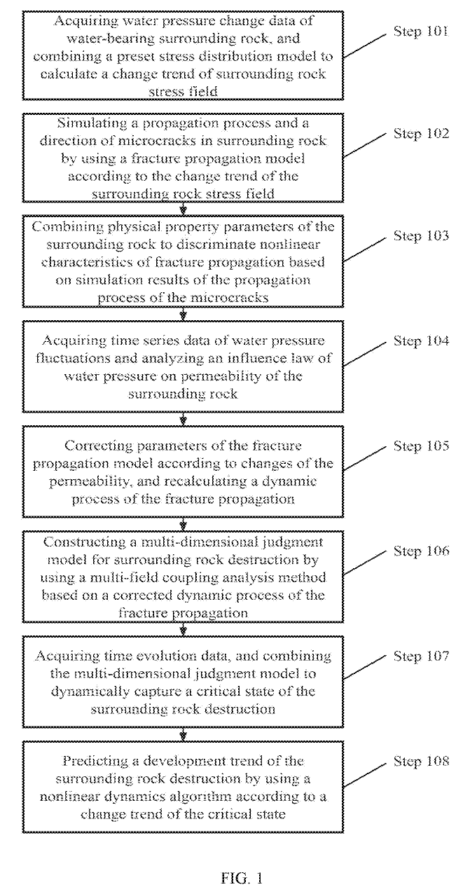

As shown in FIG. 1, the present embodiment provides a method for judging water-bearing surrounding rock destruction of underground engineering, including following steps.

Step 101, acquiring water pressure change data of water-bearing surrounding rock, and combining a preset stress distribution model to calculate change trend of the surrounding rock stress field.

The water pressure change data of the water-bearing surrounding rock is acquired, and water pressure change values are extracted; a preset stress distribution model is combined to extract stress modulus and distribution state according to the water pressure change values; and the change trend of the surrounding rock stress destruction is calculated by using a pre-established calculation method.

Specifically, the acquiring water pressure change data of water-bearing surrounding rock is an important basis for engineering safety evaluation. Taking a hydropower station as an example, real-time water pressure values are monitored through a pressure sensor network embedded in the surrounding rock. The sensors are arranged at different depths and orientations to form a three-dimensional monitoring network. Monitoring data shows that when the reservoir water level drops from the normal storage level to the dead water level, the water pressure in the shallow area of the surrounding rock drops from 0.2 megapascal (MPa) to 0.1 MPa, and that in the deep area drops from 0.5 MPa to 0.3 MPa. Water pressure changes will cause stress redistribution of the surrounding rock. Combined with a preset stress distribution model, the stress change trend may be calculated. In the case of the hydropower station, an elastoplastic mechanical model is adopted, considering the heterogeneity and anisotropy of the surrounding rock mass. When a water pressure change is monitored, the stress distribution shows obvious nonlinear characteristics, which is manifested as stress release in the shallow area and stress concentration in the deep area.

An iterative method is used to calculate the change trend of the surrounding rock stress field. When the stress in a certain area of the surrounding rock exceeds a preset critical value, the model parameters need to be adjusted. For example, when the stress value monitored at a measuring point reaches 70 percent (%) of the compressive strength of the rock mass, an early warning value is triggered, and the parameters of the stress distribution model need to be re-optimized, including adjusting key parameters such as the deformation modulus and Poisson's ratio of the rock mass. The updated stress distribution model may more accurately reflect the actual state of the surrounding rock. In practical engineering, long-term monitoring shows that the error between the predicted value of the adjusted model and the measured value is controlled within 5%, which significantly improves the prediction accuracy. This dynamic update mechanism ensures the adaptability and accuracy of the model. The dynamic change data of the surrounding rock stress field are obtained through time series analysis. In the project, through six months of continuous monitoring, the evolution process of the stress field caused by water level changes is recorded. The data show that when the water level drops rapidly, the surrounding rock stress field presents an obvious hysteresis effect, and it takes about 3 to 5 days for the stress adjustment to reach a new equilibrium state. This dynamic monitoring and analysis method may effectively predict the stability of the surrounding rock. By establishing the correlation between water pressure changes and stress field responses, abnormal changes may be found in a timely manner. For example, when it is found that the stress change rate in a certain area exceeds 0.05 MPa per day, it may be judged as an abnormal state, and protective measures such as reinforcement shall be taken in a timely manner. This prediction and protection mechanism provides a reliable guarantee for the safe operation of the project.

Step 102, simulating a propagation process and a direction of microcracks in the surrounding rock by using a fracture propagation model according to the change trend of the surrounding rock stress field.

Stress field distribution state of the surrounding rock mass is acquired, and stress values and the change trends are extracted; stress value change trends are combined to calculate a propagation direction of microcracks by using a fracture model; and a propagation process of the microcracks in the surrounding rock mass is analyzed through a simulation process.

Specifically, the stress field distribution state of the surrounding rock mass usually shows the spatial distribution law of normal stress and shear stress, where the change trend of stress values reflects the dynamic characteristics of the stress state of the surrounding rock. Taking the surrounding rock of a coal mine roadway as an example, when the vertical stress of the roof reaches 10 MPa, a typical stress concentration area will be formed inside the surrounding rock mass, and this stress concentration often becomes the main inducement for the initiation of microcracks. The establishment of a fracture model needs to consider the lithological characteristics and initial fracture distribution state of the surrounding rock. Taking sandstone surrounding rock as an example, its uniaxial compressive strength is about 50 MPa, and microcracks begin to propagate when the stress exceeds the critical value. Observations show that under the dominance of vertical stress, microcracks tend to propagate along the direction of the maximum principal stress, forming approximately parallel fracture groups. The simulation and analysis of the microcrack propagation process need to be combined with the physical and mechanical parameters of the surrounding rock. Taking shale surrounding rock as an example, its elastic modulus is about 20 gigapascal (GPa) and Poisson's ratio is 0.3. When microcracks propagate, the stress intensity factor at the crack tip reaches the critical value of 1.5 MPa·m^{0.5}, and the cracks begin to propagate unstably. The adjustment of fracture model parameters mainly considers the anisotropic characteristics of the rock mass. In an actual mine case, when the deviation between the predicted and actual microcrack propagation directions exceeds 15 degrees, it is necessary to re-evaluate the bedding direction and joint development degree of the rock mass, and correct the strength parameters in the fracture propagation criterion accordingly. The dynamic evolution process of microcrack propagation may be mastered through time series analysis. Taking a deep roadway as an example, within 24 hours after excavation, the stress redistribution of the surrounding rock leads to the rapid propagation of microcracks, with a crack length growth rate of up to 0.5 millimeters (mm) per hour, and then tends to be stable, with the growth rate dropping to less than 0.1 mm per hour. The key change points in the microcrack propagation process mainly include three stages: crack initiation, accelerated propagation and stabilization. In the initiation stage, microcracks with a length of less than 1 mm are generated inside the surrounding rock, then enter the accelerated propagation stage, where the cracks rapidly extend to the centimeter level, and finally tend to be stable after stress redistribution. These changes will directly affect the overall stability of the surrounding rock. When multiple cracks are connected, a through fracture surface may be formed, leading to the instability of the surrounding rock. The deformation characteristics of the surrounding rock mass are closely related to microcrack propagation. Through displacement monitoring, it is found that when the microcrack propagation rate reaches the critical value, the surrounding rock deformation rate increases significantly, and the deformation amount may reach the millimeter level. This change often indicates that the surrounding rock is about to enter the nonlinear deformation stage. Therefore, through the analysis of microcrack propagation laws, the stability state of the surrounding rock may be predicted, providing a basis for support design.

Step 103, combining physical property parameters of the surrounding rock to discriminate nonlinear characteristics of fracture propagation based on simulation results of the propagation process of the microcracks.

Dynamic data of the fracture propagation is generated, and key change points are extracted through time series analysis; physical property parameters of the surrounding rock are combined to analyze the nonlinear characteristic values of fracture propagation; and whether fracture propagation characteristic values reach a preset threshold is judged to determine stability state of the surrounding rock mass.

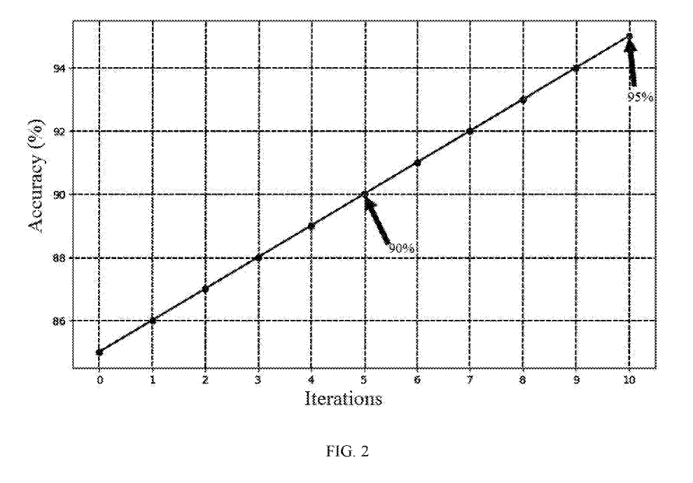

Specifically, the stress field distribution data of the surrounding rock mass usually need to consider factors such as engineering excavation disturbance and in-situ stress conditions. For example, in a deep mining project, the principal stress distribution in the surrounding rock mass is obtained by arranging strain sensors. The principal stress value gradually attenuates from the shaft wall inward, indicating that the influence of excavation disturbance gradually weakens. The stress value change trend is manifested as exponential attenuation, and the maximum principal stress at the shaft wall may reach more than three times the initial in-situ stress. The selection of a fracture propagation model needs to comprehensively consider rock mass characteristics and geological conditions. Taking a tunnel project as an example, a surrounding rock fracture propagation prediction model is established based on elastoplastic mechanics theory. The model correlates the fracture propagation direction with the maximum principal stress direction and introduces rock mass strength parameters as control factors. Verified by measured data, the deviation between the fracture propagation direction predicted by the model and the field observation result is within 15%. In terms of time series analysis, taking an underground powerhouse of a hydropower station as an example, optical fiber sensing is used to monitor the development of surrounding rock fractures. Through the analysis of six consecutive months of monitoring data, it is found that a key change point occurs in the third month after excavation, and the fracture propagation rate increases significantly. This change is related to the seasonal rainfall period, indicating that groundwater seepage has an important impact on fracture propagation. In the process of parameter set adjustment, the anisotropic characteristics of the surrounding rock mass need to be considered. Monitoring of the surrounding rock in the goaf of a mine shows that the deviation between the predicted direction of the original fracture propagation model and the actual observation reaches 30 degrees. By introducing the bedding dip angle parameter and adjusting the elastic modulus ratio, the prediction accuracy of the corrected model is improved to 95%, as shown in FIG. 2. The influence of the physical property parameters of the surrounding rock on fracture propagation is manifested as nonlinear characteristics. Taking a deep roadway project as an example, the uniaxial compressive strength of the surrounding rock mass is 80 MPa, and when the stress exceeds the critical value, the fracture propagation rate increases exponentially. Measured data show that when the surrounding rock deformation exceeds the critical value of 0.3%, microcracks begin to propagate rapidly. The judgment of the stability state needs to establish a reasonable evaluation index system. In the monitoring of the surrounding rock of a subway interval tunnel, multiple early warning indicators such as displacement and crack width are set. When the displacement rate exceeds 0.5 mm per day or the crack width exceeds 2 mm, it is judged to enter the early warning state. Combined with the numerical simulation results, the critical state threshold for the instability of the surrounding rock mass is determined, providing an important reference for engineering construction.

Step 104, acquiring time series data of water pressure fluctuations and analyzing an influence law of water pressure on permeability of the surrounding rock.

Specifically, the collection of time series data of water pressure fluctuations is the basis for studying the stability of surrounding rock. Water pressure values at different depth positions may be obtained by arranging high-precision pressure sensors. The change trend of water pressure values reflects the dynamic change of the seepage field inside the surrounding rock. For example, when the water pressure value rises rapidly to 8 MPa in a short time, it indicates that the seepage channel may have local penetration. The permeability model needs to consider factors such as the porosity and fracture development degree of the surrounding rock. Taking an underground project as an example, three groups of fractures develop in the surrounding rock, the dip angle of the main fracture is 65 degrees, and the dip angles of the secondary fractures are 40 degrees and 75 degrees respectively. The equivalent permeability coefficient may be calculated as 0.003 centimeter per second (cm/s) through the model. In time series analysis, the identification of key change points is crucial for predicting the stability of surrounding rock. For example, monitoring data show that the water pressure at a certain point rises from 2 MPa to 6 MPa within 15 days, and the rising curve is exponential. This sudden change characteristic often indicates a significant change in the permeability of the surrounding rock. When the measured permeability value exceeds the preset safe range, the model parameters need to be adjusted in a timely manner. For example, in a deep roadway project, the permeability coefficient of the surrounding rock exceeds the early warning value by 30%, and the model calculation value is more in line with the actual situation by optimizing the fracture connectivity parameter. The nonlinearity of permeability is mainly reflected in the coupling effect between the stress field and the seepage field.

In practical engineering, with the increase of groundwater pressure, the surrounding rock fractures gradually open, and the permeability coefficient increases nonlinearly. When the water pressure reaches the critical value, the permeability coefficient may jump. The physical property parameters of the surrounding rock include elastic modulus, Poisson's ratio, etc., which are closely related to permeability. The elastic modulus of the surrounding rock in a mining area is 25 GPa and Poisson's ratio is 0.28. When the surrounding rock is subjected to high water pressure, its permeability coefficient increases exponentially with the deformation of the surrounding rock. Stability evaluation needs to comprehensively consider multiple characteristic values. For example, when the permeability coefficient of the surrounding rock in a project exceeds 0.005 cm/s and the deformation reaches the warning value, it indicates that the surrounding rock has entered an unstable state, and reinforcement measures need to be taken. The results of permeability analysis may provide an important basis for engineering design and construction, ensuring the long-term stability of underground engineering.

Step 105, correcting parameters of a fracture propagation model according to changes of the permeability, and recalculating a dynamic process of fracture propagation.

The time series data of the permeability is acquired, and the change trend of the permeability is extracted; the parameter values of the model are corrected by using a preset fracture propagation model according to the change trend of the permeability; and the dynamic process of the fracture propagation is recalculated according to the corrected parameter values to obtain the evolution result of fracture propagation.

Specifically, the time series data of permeability usually reflect the fluid flow state in the surrounding rock mass, and may record the changes in permeability coefficient or permeability at fixed time intervals. For example, the permeability coefficient monitored in a water conservancy project gradually increases from the initial value of 0.05 cm/s to 0.15 cm/s. This change trend indicates that the surrounding rock structure may have changed. The fracture propagation model is a theoretical tool for describing the development of cracks inside the rock mass, and elastoplastic models or damage models are often used as the basis. For example, in the construction of an underground cavern, after initial fractures appear in the surrounding rock, displacement monitoring data show that the crack width expands from 0.2 mm to 1.5 mm, which requires correcting the model parameters, including adjusting key parameters such as the elastic modulus and Poisson's ratio of the rock mass. The dynamic process of fracture propagation involves stages such as crack initiation, propagation and penetration. Taking a tunnel project as an example, the fractures in the surrounding rock gradually develop from the micron level to the millimeter level, and finally form a connected fracture network. In this process, it is necessary to track the changes of characteristic parameters such as fracture length, opening and direction in real time. The adjustment of model parameter values is an iterative process based on measured data and theoretical calculations. For example, in a mine project, it is found that there is a deviation between the initially set rock mass strength parameters and the actual monitoring results. It is necessary to optimize the model parameters multiple times according to the on-site stress-strain data until the error between the calculation result and the measured data is within the allowable range. The nonlinear characteristics of fracture propagation are reflected in the inhomogeneity of their development rate and direction. For example, in the monitoring of the surrounding rock of a hydropower station, it is observed that the propagation rate of fractures in the stress concentration area is significantly faster than that in other areas, and the propagation direction presents a complex nonlinear relationship with the principal stress direction. These nonlinear characteristics may be quantitatively described by indicators such as fracture density and connectivity. The determination of the final state needs to comprehensively consider multiple factors. In a deep mining project, multiple thresholds for stability judgment are set by monitoring parameters such as fracture propagation rate and seepage pressure change. When the fracture propagation rate is lower than 0.01 mm per day and the fluctuation range of seepage pressure is less than 5%, the surrounding rock may be considered to reach a relatively stable state. This multi-parameter threshold judgment method may more accurately evaluate the overall stability of the surrounding rock.

Step 106, constructing a multi-dimensional judgment model for surrounding rock destruction by using a multi-field coupling analysis method based on a corrected dynamic process of the fracture propagation.

Corrected dynamic process data of the fracture propagation is acquired, and characteristic indicators of the surrounding rock destruction are extracted by using the multi-field coupling analysis method; a multi-dimensional judgment model is constructed according to the characteristic indicators of surrounding rock destruction to determine key characteristics of surrounding rock destruction; and the multi-dimensional judgment model is trained. The critical state of surrounding rock destruction is judged through the trained multi-dimensional judgment model. When the critical state of surrounding rock failure reaches a preset threshold, the parameters of the multi-dimensional judgment model are optimized by using a random forest algorithm. The multi-dimensional judgment model is updated according to the optimized model parameters to obtain the judgment result of surrounding rock failure. The evolution trend of surrounding rock destruction is analyzed by using a gradient boosting decision tree algorithm in combination with the judgment result of surrounding rock failure.

Specifically, the multi-field coupling analysis method performs coupling analysis on the mechanical field, seepage field and temperature field in the dynamic process of fracture propagation. For example, in underground engineering, the excavation process leads to the redistribution of the surrounding rock stress field, and at the same time causes changes in the groundwater seepage field, which in turn affects the distribution of the surrounding rock temperature field. Through the interaction of physical quantities such as stress-strain, seepage pressure and temperature gradient, characteristic indicators of surrounding rock failure are extracted, such as the scope of the failure area, the maximum principal stress change rate and the permeability change trend. When constructing a multi-dimensional judgment model for the characteristic indicators of surrounding rock failure, the mutual influence of multiple physical quantities needs to be considered. For example, during the excavation of the underground powerhouse of a hydropower station, the main physical quantities include the surrounding rock deformation, seepage pressure and fracture opening. By establishing a multi-dimensional judgment model, it is determined that the key characteristic values are when the surrounding rock deformation reaches 10 cm, the seepage pressure exceeds 0.5 MPa and the fracture opening is greater than 1 mm. When training the multi-dimensional judgment model by using the support vector machine algorithm, historical engineering case data are used as training samples. For example, in a tunnel project, monitoring data such as surrounding rock deformation, stress and seepage are collected to establish a training data set. The low-dimensional features are transformed into a high-dimensional feature space through kernel function mapping, and the optimal classification hyperplane is found to realize the accurate judgment of the surrounding rock failure state. The judgment of the critical state of surrounding rock failure is based on the output result of the multi-dimensional judgment model. When the model output value is close to the preset threshold, it indicates that the surrounding rock is in a critical failure state. For example, in a mine project, when the support pressure exceeds 20 MPa and the surrounding rock displacement rate is greater than 0.5 mm per day, it is judged as a critical state. When optimizing the parameters of the multi-dimensional judgment model by using the random forest algorithm, ensemble learning is performed by constructing multiple decision trees. For example, in a subway project, decision trees are constructed by using different feature combinations, and the optimal parameter combination is determined by using a voting mechanism. The optimized model may more accurately reflect the evolution law of surrounding rock failure. When analyzing the evolution trend of surrounding rock failure by using the gradient boosting decision tree algorithm, the model prediction accuracy is improved through iterative training. For example, in a goaf project, the time series data of surrounding rock failure are used to train the model to predict the development trend of surrounding rock deformation in a future period of time. When the prediction result shows that the surrounding rock deformation rate continues to increase and the displacement exceeds the early warning value, reinforcement and support measures are taken in a timely manner. Extracting characteristic indicators through multi-field coupling analysis and constructing a judgment model combined with machine learning algorithms may effectively predict the evolution process of surrounding rock failure, providing an important basis for engineering safety early warning and risk prevention and control. At the same time, the parameter optimization and continuous update of the multi-dimensional judgment model ensure the accuracy and reliability of the model prediction results.

Step 107, acquiring time evolution data, and combining the multi-dimensional judgment model to dynamically capture a critical state of surrounding rock destruction.

The time series data in the evolution process of the surrounding rock is acquired, and evolution characteristics are extracted; extracted evolution characteristics are dynamically captured by using the multi-dimensional judgment model; and the critical state of surrounding rock destruction is determined when the dynamically captured characteristics meet the preset critical state conditions.

Specifically, during the evolution of the surrounding rock, time series data such as surrounding rock deformation and stress values are acquired by arranging monitoring equipment such as displacement sensors and stress sensors. For example, in the monitoring of the surrounding rock of a deep roadway, data are collected once per hour for three consecutive months, and the change process of the roof subsidence of the surrounding rock from the initial 0 mm to 120 mm is obtained. The extracted evolution characteristics include dynamic parameters such as deformation rate and acceleration, as well as geometric characteristics such as fracture propagation length and opening. The multi-dimensional judgment model realizes the dynamic capture of the evolution characteristics of the surrounding rock by constructing a feature space. Taking a mine roadway as an example, a feature space including the stress field, displacement field and fracture field is established. When it is monitored that the surrounding rock stress exceeds the critical strength, the deformation rate suddenly increases and the fracture propagation speed accelerates, it may be determined that the surrounding rock enters a critical failure state. Specifically, the roof subsidence rate suddenly increases from 0.5 mm per day to 3 mm per day, and the surrounding rock stress exceeds 80% of the rock mass compressive strength. The support vector machine algorithm optimizes the judgment model parameters by finding the optimal classification hyperplane. For example, in the monitoring of the surrounding rock of a mine roadway, characteristic parameters such as stress, deformation and fractures are selected to construct training samples, and the nonlinear problem is transformed into a linearly separable problem through kernel function mapping to realize the accurate judgment of the surrounding rock failure state. The classification accuracy of the optimized model is improved from the original 85% to 92%. The gradient boosting decision tree algorithm analyzes the evolution trend of surrounding rock failure by constructing a sequence of weak learners. Taking a mine roadway as an example, characteristics such as surrounding rock deformation, stress and fractures are used as input variables to predict the development trend of the surrounding rock failure degree. The analysis results show that when the roof subsidence rate continues to exceed 3 mm per day and the surrounding rock stress continues to increase and exceeds the critical strength, the surrounding rock will undergo large-scale failure within 7 to 10 days. When determining the final state through evolution trend analysis, multiple factors need to be comprehensively considered. For example, after experiencing stages such as initial damage, fracture propagation and critical instability, the surrounding rock of a mine roadway may eventually undergo failure forms such as large-area roof caving and severe deformation of the two walls. Specifically, the roof subsidence exceeds 200 mm, the deformation of the two walls exceeds 300 mm, and through fractures are visible on the surface of the surrounding rock. These characteristics collectively indicate that the surrounding rock has entered an irreversible failure state.

Step 108, predicting a development trend of surrounding rock destruction by using a nonlinear dynamics algorithm according to a change trend of the critical state.

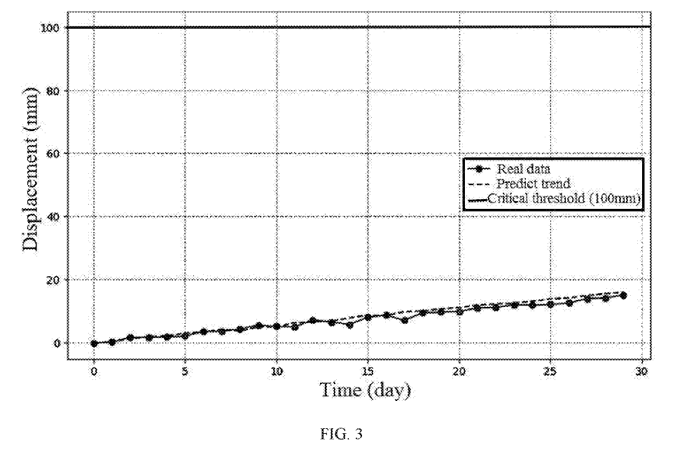

Time series data of a surrounding rock mass is acquired, and characteristic values in an evolution process of the surrounding rock are extracted; a prediction model is established by using a nonlinear dynamics algorithm according to a change trend of characteristic values; and a development trend of the surrounding rock destruction is analyzed through the prediction model, as shown in FIG. 3.

Specifically, the time series data of the surrounding rock mass mainly include displacement changes, stress changes and acoustic emission data, which are collected in real time through sensors. Taking tunnel construction as an example, the displacement data of the surrounding rock mass may be continuously monitored by using multi-point extensometers, and data are recorded once per hour to form a time series data set. In the process of feature value extraction, changes such as displacement increment, displacement rate and acceleration may be analyzed, and the change law of stress data is combined. In nonlinear dynamics analysis, a phase space reconstruction technology may be used to establish a prediction model. Taking a tunnel project as an example, a one-dimensional time series is reconstructed into a multi-dimensional phase space through embedding dimension and time delay parameters, so as to reveal the dynamic characteristics of the surrounding rock evolution process. When the surrounding rock mass enters a critical state, the displacement curve will show obvious nonlinear characteristics, such as mutation points or accelerated development stages. When judging the critical state of surrounding rock failure, multiple indicators need to be comprehensively considered. For example, in a mine roadway, when the surrounding rock displacement rate exceeds 0.5 mm per hour for more than 4 hours, accompanied by a large number of microseismic signals, it may be determined to enter a critical state. In the optimization process of the support vector machine algorithm, monitoring data such as displacement and stress are used as training samples, which are mapped to a high-dimensional feature space through kernel functions, and a classification hyperplane is established to realize the accurate identification of the critical state. The update of the prediction model is mainly based on the newly added monitoring data. Taking an underground powerhouse as an example, when the newly added data show that the surrounding rock deformation rate increases significantly, the prediction model needs to adjust the relevant parameter weights in a timely manner to improve the prediction accuracy. Trend analysis may predict the deformation development in a certain period of time in the future, providing a decision-making basis for engineering disposal. When verifying the model by using the gradient boosting decision tree algorithm, historical data may be divided into a training set and a test set. Taking a deep mine stope as an example, 70% of the data are selected as the training set, and the remaining data are used for testing. The prediction ability of the model is evaluated by comparing the error between the predicted value and the measured value. When the prediction accuracy reaches more than 85% and the dispersion degree of the prediction results is small, it indicates that the model has good stability. The model may be used to guide engineering practice, find potential surrounding rock instability risks in a timely manner, and provide a scientific basis for active prevention and treatment.

### Embodiment 2

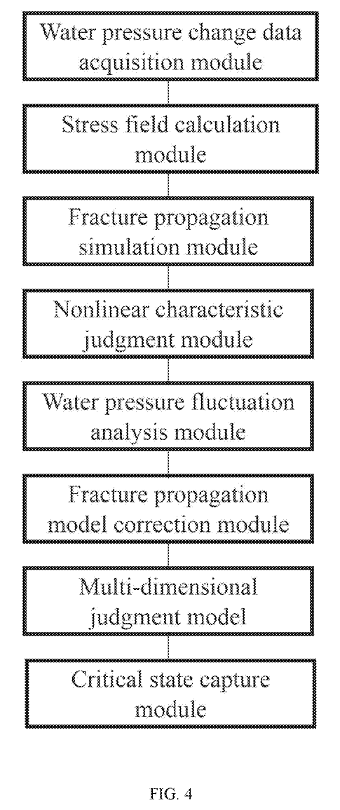

As shown in FIG. 4, based on the same inventive concept, the present embodiment also provides a system for judging water-bearing surrounding rock destruction of underground engineering. The system includes:
a water pressure change data acquisition module, configured for acquiring water pressure change data of a water-bearing surrounding rock, and combining a preset stress distribution model to calculate a change trend of surrounding rock stress field;
a stress field calculation module, configured for simulating a propagation process and a direction of microcracks in a surrounding rock by using a fracture propagation model according to a change trend of stress field;
a fracture propagation simulation module, configured for combining physical property parameters of the surrounding rock to discriminate nonlinear characteristics of fracture propagation based on simulation results of the propagation process of fracture;
a nonlinear characteristic judgment module, configured for acquiring time series data of water pressure fluctuations and analyzing an influence law of water pressure on permeability of the surrounding rock;
a water pressure fluctuation analysis module, configured for correcting parameters of the fracture propagation model according to changes in the permeability, and recalculating the dynamic process of fracture propagation;
a fracture propagation model correction module, configured for constructing a multi-dimensional judgment model for the surrounding rock destruction by using a multi-field coupling analysis method based on a corrected dynamic process of fracture propagation;
a multi-dimensional judgment model construction module, configured for acquiring time evolution data, and combining the multi-dimensional judgment model to dynamically capture critical state of the surrounding rock destruction; and
a critical state capture module, configured for predicting a development trend of the surrounding rock destruction by using a nonlinear dynamics algorithm according to the change trend of the critical state.

The system for judging water-bearing surrounding rock destruction of underground engineering provided by the present embodiment has all the advantages of the method for judging water-bearing surrounding rock destruction of underground engineering provided by Embodiment 1.

### Embodiment 3

The present embodiment also discloses a computer program product, including a computer program, where the computer program product implements the steps of the method described in Embodiment 1, when the computer program product is executed by a processor

The above are only preferred specific implementations of the present disclosure, but the protection scope of the present disclosure is not limited thereto. Any person skilled in the technical field may easily think of changes or substitutions within the technical scope disclosed in the present disclosure, which shall be covered in the protection scope of the present disclosure. Therefore, the protection scope of the present disclosure shall be subject to the protection scope of the claims.

What is claimed is:

1. A method for judging water-bearing surrounding rock destruction of underground engineering, comprising following steps:
acquiring water pressure change data of water-bearing surrounding rock, and combining a preset stress distribution model to calculate a change trend of surrounding rock stress field;
simulating a propagation process and a direction of microcracks in surrounding rock by using a fracture propagation model according to the change trend of the surrounding rock stress field;
combining physical property parameters of the surrounding rock to discriminate nonlinear characteristics of fracture propagation based on simulation results of the propagation process of the microcracks;
acquiring time series data of water pressure fluctuations and analyzing an influence law of water pressure on permeability of the surrounding rock;
correcting parameters of the fracture propagation model according to changes of the permeability, and recalculating a dynamic process of the fracture propagation;
constructing a multi-dimensional judgment model for surrounding rock destruction by using a multi-field coupling analysis method based on a corrected dynamic process of the fracture propagation;
acquiring time evolution data, and combining the multi-dimensional judgment model to dynamically capture a critical state of the surrounding rock destruction; and
predicting a development trend of the surrounding rock destruction by using a nonlinear dynamics algorithm according to a change trend of the critical state.

2. The method according to claim 1, wherein
steps of the calculating the change trend of the surrounding rock stress destruction comprise:
acquiring the water pressure change data of the water-bearing surrounding rock, and extracting water pressure change values;
combining the preset stress distribution model to extract stress modulus and distribution state according to the water pressure change values; and
calculating the change trend of the surrounding rock stress destruction by using a pre-established calculation method.

3. The method according to claim 1, wherein
steps of the simulating the propagation process and the direction of the microcracks in the surrounding rock comprise:
acquiring stress field distribution state of surrounding rock mass, and extracting stress values and change trend thereof;
combining the change trend of the stress values to calculate a propagation direction of the microcracks by using a fracture model; and
analyzing the propagation process of the microcracks in the surrounding rock mass through a simulation process.

4. The method according to claim 1, wherein
steps of the discriminating the nonlinear characteristics of the fracture propagation comprise:
generating dynamic data of the fracture propagation, and extracting key change points through time series analysis;
combining the physical property parameters of the surrounding rock to analyze values of the nonlinear characteristic of the fracture propagation; and
judging whether fracture propagation characteristic values reach a preset threshold to determine stability state of surrounding rock mass.

5. The method according to claim 1, wherein
steps of the recalculating the dynamic process of the fracture propagation comprise:
acquiring the time series data of the permeability, and extracting change trend of the permeability;
using a preset fracture propagation model to correct values of the parameters of the model according to the change trend of the permeability; and
recalculating the dynamic process of the fracture propagation according to corrected values of the parameters to obtain evolution result of the fracture propagation.

6. The method according to claim 1, wherein
steps of the constructing the multi-dimensional judgment model for the surrounding rock destruction by using the multi-field coupling analysis method comprise:
acquiring data of the corrected dynamic process of the fracture propagation, and extracting characteristic indicators of the surrounding rock destruction by using the multi-field coupling analysis method;
constructing the multi-dimensional judgment model according to the characteristic indicators of the surrounding rock destruction to determine key characteristics of the surrounding rock destruction; and
training the multi-dimensional judgment model by using a support vector machine algorithm according to the key characteristics of the surrounding rock destruction to obtain a trained multi-dimensional judgment model.

7. The method according to claim 1, wherein
steps of the dynamically capturing the critical state of the surrounding rock destruction comprise:
acquiring time series data in an evolution process of the surrounding rock, and extracting evolution characteristics;
dynamically capturing extracted evolution characteristics by using the multi-dimensional judgment model; and
determining the critical state of the surrounding rock destruction when dynamically captured characteristics meet preset critical state conditions.

8. The method according to claim 1, wherein
steps of the predicting the development trend of the surrounding rock destruction comprise:
acquiring time series data of a surrounding rock mass, and extracting characteristic values in an evolution process of the surrounding rock;
establishing a prediction model by using the nonlinear dynamics algorithm according to a change trend of the characteristic values; and
analyzing the development trend of the surrounding rock destruction through the prediction model.

9. A system for judging water-bearing surrounding rock destruction of underground engineering, wherein the system comprises:
a water pressure change data acquisition module, configured for acquiring water pressure change data of a water-bearing surrounding rock, and combining a preset stress distribution model to calculate a change trend of a surrounding rock stress field;
a stress field calculation module, configured for simulating a propagation process and a direction of microcracks in a surrounding rock by using a fracture propagation model according to the change trend of the stress field;
a fracture propagation simulation module, configured for combining physical property parameters of the surrounding rock to discriminate nonlinear characteristics of fracture propagation based on simulation results of the propagation process of fracture;
a nonlinear characteristic judgment module, configured for acquiring time series data of water pressure fluctuations and analyzing an influence law of water pressure on permeability of the surrounding rock;
a water pressure fluctuation analysis module, configured for correcting parameters of the fracture propagation model according to changes in the permeability, and recalculating dynamic process of the fracture propagation;
a fracture propagation model correction module, configured for constructing a multi-dimensional judgment model for surrounding rock destruction by using a multi-field coupling analysis method based on a corrected dynamic process of the fracture propagation;
a multi-dimensional judgment model construction module, configured for acquiring time evolution data, and combining the multi-dimensional judgment model to dynamically capture critical state of the surrounding rock destruction; and
a critical state capture module, configured for predicting a development trend of the surrounding rock destruction by using a nonlinear dynamics algorithm according to change trend of the critical state.

10. A computer program product, comprising a computer program, wherein the computer program product implements the steps of the method according to claim 1, when the computer program product is executed by a processor.
